(19) United States
(12) Patent Application Publication
(10) Pub. No.: US 2011/0171351 A1
(43) Pub. Date: Jul. 14, 2011

(54) Utensil and method

(76) Inventor: Kfir Ohayon, Migdal Tefen Industrial Park (IL)

(21) Appl. No.: 12/929,268

(22) Filed: Jan. 12, 2011

Related U.S. Application Data
(60) Provisional application No. 61/335,888, filed on Jan. 14, 2010.

(51) Int. Cl. A23L 1/00; A23P 1/08; A23P 1/10

(52) U.S. Cl. 426/132; 426/421

(57) ABSTRACT

A utensil may be provided with at least one utensil body extending generally longitudinally and having consumables integrally disposed thereon.

### CROSS-REFERENCE TO RELATED APPLICATIONS

This application claims priority to U.S. Provisional Patent Application Ser. No. 61/335,888, filed Jan. 14, 2010, titled “Utensil and Method”.

### FIELD OF THE INVENTION

The present disclosure is generally directed to utensils, which may used, by way of example only, to be applied to beverage, and to such utensils having cured consumables integrally formed therewith, as well as a method of manufacturing thereof.

### BACKGROUND OF THE INVENTION

Generally, utensils such as, but not limited to, spoons, teaspoons and/or forks, or generally similar, are used in a wide variety of applications to serve, stir or consume different victuals. For example, utensils are used to ensure the mixing of sugar in a cup of coffee, homogenization of syrups in a glass, or for eating certain foods, such as, but not limited to, soup, grains, porridges and similar victuals.

As an illustrative, non-limiting example only, in the fast food field, more and more use is being made of utensils intended for a one-time use. Thus, consumables may be packed in individual portions and/or in disposable packages. One example may include, but is not limited to, sugar, intended to be used in, for example, drinks, packaged in packets, with the sugar being, as an example only, in a powder or cubed form. Other non-limiting examples may include coffee, tea, sweeteners, milk and/or whiteners, or seasonings.

Such packaging may require a supply both of utensils and of measured quantities of consumables. Moreover, if such quantities of consumables are left at the disposal of consumers, they may deteriorate, and, thus, become unfit for consumption.

U.S. Pat. No. 3,869,555 to Heonis Angelo Alexander discloses “A dry article for the preparation of instant beverages when combined with a liquid. The article comprises a stick, a first solid, liquid-soluble mass comprising beverage base material and at least one second solid, liquid-soluble mass comprising flavoring material for said base material. The first and second masses are bonded to the stick in side-by-side relationship, the second or flavoring mass being adjacent one end of the stick so that it can be removed if the user prefers to prepare the beverage without the flavoring material. The stick serves as a handle for the dry article and as a stirrer to facilitate dissolution of the base material and the flavoring material, if present, in the liquid.”

U.S. Pat. No. 3,312,555 to Emil R. Rossi discloses “A handle-anchored formed sugar block designed to be used for stirring a beverage in a container, comprising a self-supporting block of dry cane sugar crystals containing about 3% to about 20% by weight of dry sugar crystals in needle form, and about 0.2% to about 10% of an edible, dry, solid lubricant, said block having a hardness value of at least 10 kg. on the Strong Cobb-Arner hardness testing machine, and a stick having a cylindrical portion penetrating substantially completely through the entire length of said block, and having a portion extending out of said block to serve as a handle for stirring said block in a beverage.”

These may be improved with the subject matter in accordance with the claims.

### SUMMARY OF THE INVENTION

In the following disclosure, aspects thereof are described and illustrated in conjunction with systems and methods which are meant to be exemplary and illustrative, not limiting in scope.

The present disclosure is broadly related to utensils having a utensil body integrally formed with cured consumables thereon.

According to an aspect of the present disclosure, there is provided a utensil comprising an elongated utensil body at least one rear shank and at least one front blade, the blade being integrally formed with cured consumables, the cured consumables are formed by curing raw or moistened raw consumables in an elevated-temperature environment.

Possibly, the moistened raw consumables are moistened with water.

Optionally, water content in the moistened raw consumables are well below a proportion needed to liquidate the moistened raw consumables.

Possibly, the utensil body extends longitudinally from a front task end to a rear free end to define a longitudinal direction L.

Possibly, curing takes place by heating the moistened consumables in an at least one cavity of a tray in an heating environment.

Possibly, curing occurs at low enough temperatures to avoid affecting chemical properties of the raw consumables.

According to another aspect of the present disclosure, an exemplary method of manufacturing a utensil integrally formed with consumables, the method comprising the steps of: (a) providing a utensil body; (b) providing an at least one cavity to which raw consumables are poured; (c) inserting a blade of the utensil body to at least one cavity onto raw consumables already in the at least one tray; (d) providing a heating environment for accommodating the at least one cavity; (d) allowing consumables to cure in the at least one cavity, thereby integrally forming cured consumables about the utensil body; and (e) removing the utensil from the at least one cavity.

Potentially, the method comprising a further step of moistening the poured raw consumables while in the at least one cavity.

Optionally, the method comprising a further step of moistening the poured raw consumables before raw consumables are poured to the at least one cavity.

Potentially, steps (b), (c) and (e) involve moistened consumables.

Possibly, the method comprises a step of curing raw consumables about the at least one utensil body while in a heating environment.

Further optionally, while in the heating environment, raw consumables are cured essentially without altering chemical characteristics thereof.

Alternatively, while in the heating environment, moistened consumables are cured essentially without altering chemical characteristics thereof.

Possibly, no binder is introduced to the raw consumables.

Alternatively, no solvent beyond water mist is introduced to the raw consumables.

Further optionally, in no step of the method moistened consumables may take a form of a slurry.

Additionally, in no step of the method moistened consumables may be a solution.

Potentially, raw or moistened consumables deposited in the at least one cavity may be press-molded by a die.

In addition to the exemplary aspects and embodiments described above, further aspects and embodiments will become apparent by reference to the figures and by study of the following detailed descriptions.

### BRIEF DESCRIPTION OF THE DRAWINGS

Exemplary embodiments are illustrated in referenced figures and drawings. It is intended that the embodiments and figures disclosed herein are to be considered illustrative rather than restrictive.

Reference will now be made to the accompanying drawings, in which:

FIG. 1 is a schematic sectional view of a utensil having a utensil body integrally formed with cured consumables;

FIGS. 2A-2F schematically show, in a flow chart mode, one possible implementation of an exemplary process of producing a utensil such as that shown schematically in FIG. 1.

### DETAILED DESCRIPTION

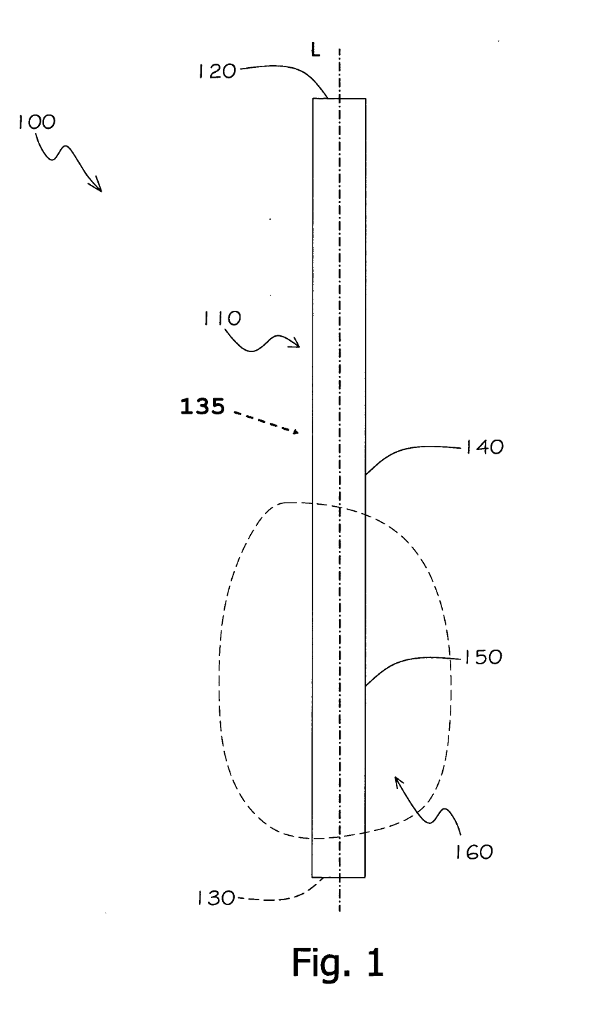

Attention is presently drawn to Figures. A utensil 100, a general, schematic, illustrative only example of which can be seen in FIG. 1, may generally have a utensil body 110 extending generally longitudinally away from a rear free end 120 to a front task end 130, to define a longitudinal direction L. The utensil body 110 may be made of any known or discovered applicable material, including, as a non-binding example, natural materials, such as, but not limited to, wood, paper (including, but not limited to, different sorts of cardboard and/or pressed paper) and/or any applicable natural and/or synthetic material and/or plastic and/or polymer.

The utensil body 110 may have at least one shank 140 adjacent to, and extending away from, the free end 120, and at least one blade 150 adjacent to, and extending away from, the task end 130, to merge with the at least one shank 140 in a transition 135. The at least one shank 140 and the at least one blade 150 may be different in function only, as will be further described herein below, and may constitute an integral structure, whose different parts may differ only in function during and after production of the utensil 100.

The at least one shank 140 may be grasped in a person's fingers or hand, and the at least one blade 150 may be used to handle cured consumables 160.

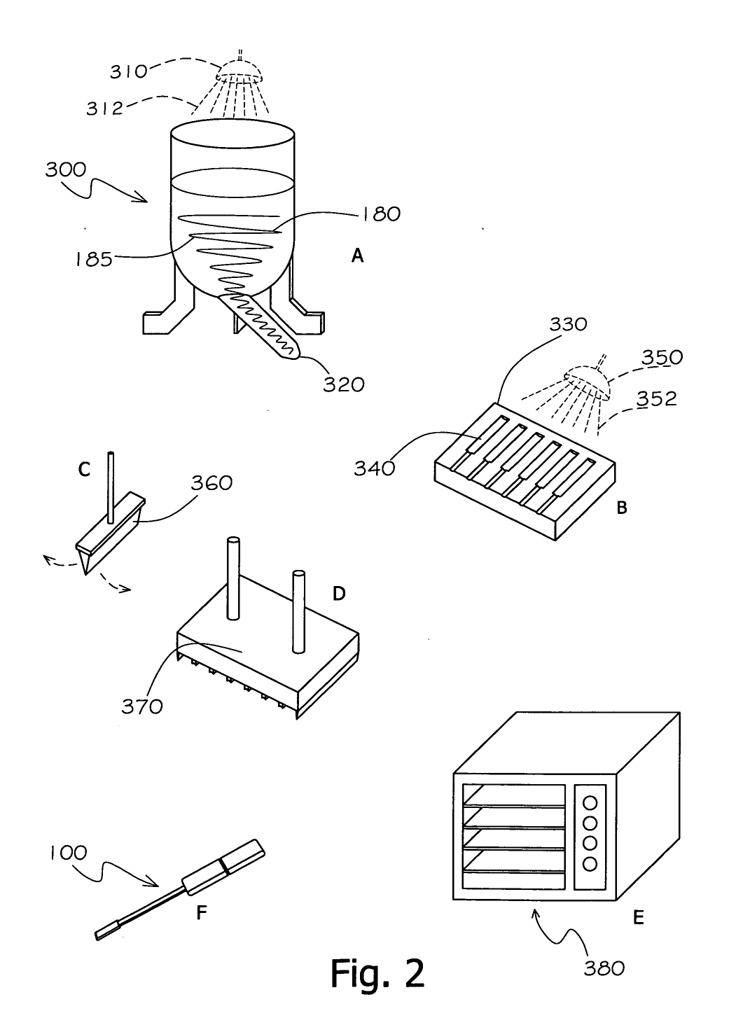

Cured consumables 160 may be formed of raw consumables 180, illustrated schematically only in FIG. 2. Generally, raw consumables 180, of any viable composition, may include, by way of non-binding, non-limiting examples, sugar, sweeteners, seasoning, soup ingredients and/or food supplements and/or medication. Such raw consumables 180 may be formed about the blade 150 to fashion cured consumables 160, as may be elaborated herein below.

A schematic, illustrative-only process for integrally-forming raw consumables 180 about a utensil body 110, may be generally represented in FIG. 2, and may comprise a step of preparing (such as, but not limited to, mixing, crushing, etc.) raw consumables 180 in a container 300 (See FIG. 2A). The container 300 may optionally comprise a mixer (not shown). An optional container sprinkler 310 may be employed to add a measure of water 312 to moisten the raw consumables 180, to raise its humidity, without turning the raw consumables 180 to a solution (that is, without dissolving and/or liquidating the raw consumables 180) to produce moistened consumables 185.

A hopper 320 may be employed to transfer the raw consumables 180 or the moistened consumables 185 from the container 300 to a tray 330 having at least one cavity 340 fashioned therein (see FIG. 2B). Alternatively, an optional tray sprinkler 350 may be employed to spray water 352 onto the at least one cavity 340 to produce the moistened consumables 185 while the raw consumables 180 are already deposited in the at least one cavity 340 of the tray 330. Further optionally, an optional squeegee 360 (as may be schematically illustrated in FIG. 2C) may be employed to wipe excess raw consumables 180 or moistened consumables 185 off the tray 330.

At least one utensil body 110 may be inserted and/or put in and/or on the at least one cavity 340. Subsequently, a die 370 (schematically shown on FIG. 2D) may fit on the at least one cavity 340 and may press-mold the raw consumables 180 about the utensil body 110 disposed in and/or on the at least one cavity 340. After press-molding, the tray 330 may be transferred to, and/or passed through, an heating environment 380 (schematically shown on FIG. 2E). While staying in and/or passing through the heating environment 380, raw consumables 180 and/or moistened consumables 185 may be cured, to form cured consumables 160 integrally about the utensil body 110 (as may be schematically shown on FIG. 2F).

Optionally, curing may occur at temperatures sufficiently lower than such temperature which may cause alteration of the raw consumables 180, or allow only for as little modification as possible. Optionally, curing may substantially occur at temperatures well below melting, or causing any substantial chemical reaction (such as, for illustrative only purposes, but not limited to, oxidation and/or caramelizing and/or baking) of the raw consumables.

After passing through the heating environment 380, the utensil body 110, now integrally formed with the cured consumables 160, constituting the utensil 100, may be removed from the at least one cavity 340 of the tray 330, and continue through optional counting, wrapping, and/or packaging stages (not shown) or any other known or discovered post-curing operation.

Potentially, the entire process takes place without introducing any binder to the raw consumables and/or to the cured consumables. Further potentially, no solvent, other that water mist, is introduced in the process. Yet further potentially, in no stage of the process does the raw consumable may comprise either a slurry or a solution.

While a number of exemplary aspects and embodiments have been discussed above, those of skill in the art will recognize certain modifications, permutations, adaptations, additions and/or sub-combinations thereof. It is therefore intended that the follow appended claims and claims hereafter introduced be interpreted to include all such modifications, permutations, additions and sub-combinations as are within their true spirit and scope. Such exemplary modifications, permutations, adaptations, additions and/or sub-combinations may include, but are not limited to, using split and/or several part forms, in which case pins, screws and/or general fasteners may be used to clamp the split and/or several part forms together, using a conveyer to transport forms, filling the form and wiping it with, for example, a wiper, inserting and/or disposing the blade in the form, pressing and/or combining pressing and heating the form, opening the split and/or several part form or forms, removing the now integrally formed utensil and/or transporting it to further treatment, such as further heating, drying and/or dehydrating stages, and/or packaging. It is to be understood some features are shown or described to illustrate the use of the present disclosure in the context of functional elements and such features may be omitted within the scope of the present disclosure and without departing from the spirit of the present disclosure as defined in the appended claims.

All directional references (such as, but not limited to, upper, lower, upward, downward, left, right, leftward, rightward, top, bottom, above, below, vertical, horizontal, clockwise, and counter-clockwise, tangential, axial and/or radial, or any other directional and/or similar references) are only used for identification purposes to aid the reader's understanding of the embodiments of the present disclosure, and may not create any limitations, particularly as to the position, orientation, or use unless specifically set forth in the claims. Similarly, joinder references (such as, but not limited to, attached, coupled, connected, and the like) are to be construed broadly and may include intermediate members between a connection of elements and relative movement between elements. As such, joinder references may not necessarily infer that two elements are directly connected and in fixed relation to each other.

In some instances, components are described with reference to “ends” having a particular characteristic and/or being connected with another part. However, those skilled in the art will recognize that the present disclosure is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like.

Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

Similarly, adjectives such as, but not limited to, “articulated”, “modified”, or similar, should be construed broadly, and only as nominal, and may not create any limitations, not create any limitations, particularly as to the description, operation, or use unless specifically set forth in the claims.

While the entire discussion relates to a seated position as a first position, and to a prone position as a second position, the opposite may equally apply, that is, the patient may be initially positioned in the prone position, and transferred passively to the seated position. Additionally, the patient may be positioned on the therapeutic apparatus in any interim position, and transferred substantially passively to any other position, either any interim position between the seated and prone positions, or the first and second positions themselves.

In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure as set forth in the claims. It is intended that all matter contained in the above description or shown in the accompanying drawings shall be interpreted as illustrative only and not limiting. Changes in detail or structure may be made without departing from the spirit of the present disclosure as defined in the appended claims.

1. A utensil comprising an elongated utensil body at least one rear shank and at least one front blade, the blade being integrally formed with cured consumables, the cured consumables are formed by curing moistened raw consumables in a heated environment.

2. The utensil of claim 1, wherein the moistened raw consumables are moistened with water.

3. The utensil of claim 2, wherein water content in the moistened raw consumables are well below a proportion needed to liquidate the moistened raw consumables.

4. The utensil of claim 1, wherein the utensil body extends longitudinally from a front task end to a rear free end to define a longitudinal axis L.

5. The utensil of claim 1, wherein drying takes place by heating the moistened consumables in an at least one cavity of a tray in said heated environment.

6. The utensil of claim 5, wherein heating is at low enough temperatures to avoid affecting chemical properties of the raw consumables.

7. A method for manufacturing a utensil integrally formed with consumables, the method comprising the steps of:
a. providing a utensil body;
b. providing an at least one cavity to which raw consumables are poured;
c. introducing a blade of an at least one utensil body to at least one cavity containing raw consumables;
d. providing a heated environment;
e. allowing raw consumables to cure in the at least one cavity in a heated environment, thereby integrally forming cured consumables about the utensil body;
f. removing the utensil from the at least one cavity.

8. The method of claim 7, wherein the method comprising a further step of moistening the poured raw consumables while in the at least one cavity of the tray.

9. The method of claim 7, wherein the method comprising a further step of moistening the poured raw consumables before raw consumables are poured to the at least one cavity of the tray.

10. The method of claim 7, wherein steps (b), (c) and (e) involve moistened consumables.

11. The method of claim 7, wherein step (e) occurs essentially without altering chemical characteristics of the raw consumables.

12. The method of claim 10, wherein step (e) occurs essentially without altering chemical characteristics of the moistened consumables.

13. The method of claim 7, wherein no binder is introduced to the raw consumables.

14. The method of claim 10, wherein no binder is introduced to the raw consumables.

15. The method of claim 10, wherein no solvent beyond water mist is introduced to the raw consumables.

16. The method of claim 10, wherein no step of the method moistened consumables may take a form of a slurry.

17. The method of claim 10, wherein no step of the method moistened consumables may take a form of a solution.

18. The method of claim 7, wherein the method comprises introducing a further step of press-molding raw consumables between step (c) and step (d).

19. The method of claim 10, wherein the method comprises introducing a further step of press-molding raw consumables between step (c) and step (d).
